(19) United States
(12) Patent Application Publication
(10) Pub. No.: US 2009/0277292 A1
(43) Pub. Date: Nov. 12, 2009

(54) Precision drive mechanism for long-travel microscopy stage

(76) Inventors: Steven Charles Quarre, Woodinville, WA (US); Kyle Justin Curts, Issaquah, WA (US)

Correspondence Address: OLYMPIC PATENT WORKS PLLC, P.O. BOX 4277, SEATTLE, WA, 98104, US

(21) Appl. No.: 12/387,473

(22) Filed: Apr. 30, 2009

Related U.S. Application Data
(60) Provisional application No. 61/049,384, filed on Apr. 30, 2008.

(51) Int. Cl. F16H 25/20

(52) U.S. Cl. 74/89.23

(57) ABSTRACT

It is a goal of the proposed invention to provide “encoder-like” performance without incurring the cost and complexity of a closed loop system.

### CROSS-REFERENCE TO RELATED APPLICATION

This application claims the benefit of Provisional Application No. 61/049,384, filed Apr. 30, 2008.

### TECHNICAL FIELD

Aspects of the present invention relates to the field of mechanical stages, and, more specifically to methods and systems for improving positional repeatability in long-travel microscope stages.

### BACKGROUND

In the field of microscopy stages, a significant problem is how to achieve sub-micron positional repeatability performance for long-travel applications. Long-travel may, for example, include stage translations of greater than approximately 50 mm. For stage translation in a single axis, there are two key mechanical components: the drive mechanism and the bearing system. Successful, sub-micron repeatability drive mechanisms have used motor-driven micrometer screw actuators. However, travel on these devises has been limited to less than or equal to 50 mm. For this reason traditional ball screws or lead screws coupled to motors, along with their bearing end supports have been utilized for travel greater than or equal to 50 mm.

A traditional ball screw assembly consists of a screw, translating nut, fixed bearing end support, and simple bearing end support. This assembly can provide as much travel as needed. It is limited primarily only in the practical length of the screw. Due to the use of rotating/re-circulating bearings in the nut and fixed end support, the assembly can produce low-friction, smooth motion. However, these same bearings also create a non-optimum condition for positional repeatability because by design there are numerous parts (ball bearings) moving relative to other parts (fixed bearing races) during translation of the mechanism. A non-kinematic condition thus exists and produces a condition where the mechanism will move to a different axial position when commanded to move to a single position multiple times. This condition is known as “repeatability error”. It is typical that a traditional ball screw specified for a microscopy translation stage will have a repeatability error of approximately 1.0 micron. This performance can be improved by the use of a linear encoder device that measures the location of the translating nut relative to a fixed reference. A ball screw mechanism driven with linear encoder feedback can dramatically improve positioning performance; however, the cost and complexity are also increased.

What is needed in the field is a solution that provides “encoder-like” repeatability without incurring the cost and complexity associated with a closed loop system.

### SUMMARY

It is a goal of the proposed invention to provide “encoder-like” performance without incurring the cost and complexity of a closed loop system.

### BRIEF DESCRIPTION OF THE DRAWINGS

FIG. 1(a) illustrates one embodiment of the present invention in which a lead screw is coupled at one end to a fixed bearing end support by a non-rotating ball and cone assembly.

FIG. 1(b) illustrates a traditional ball screw drive.

FIG. 2 illustrates one embodiment of the present invention in which the precision drive mechanism is rigidly attached to a linear slide bearing.

FIG. 3 illustrates alternate views of one embodiment of the present invention.

### DETAILED DESCRIPTION OF THE INVENTION

Certain embodiments of the present invention are illustrated in the attached drawings and are discussed below. The present invention specifically addresses two key areas: the elimination of intermediary parts and the employment of stiff axial motion while allowing for virtually unconstrained movement in all other degrees of freedom.

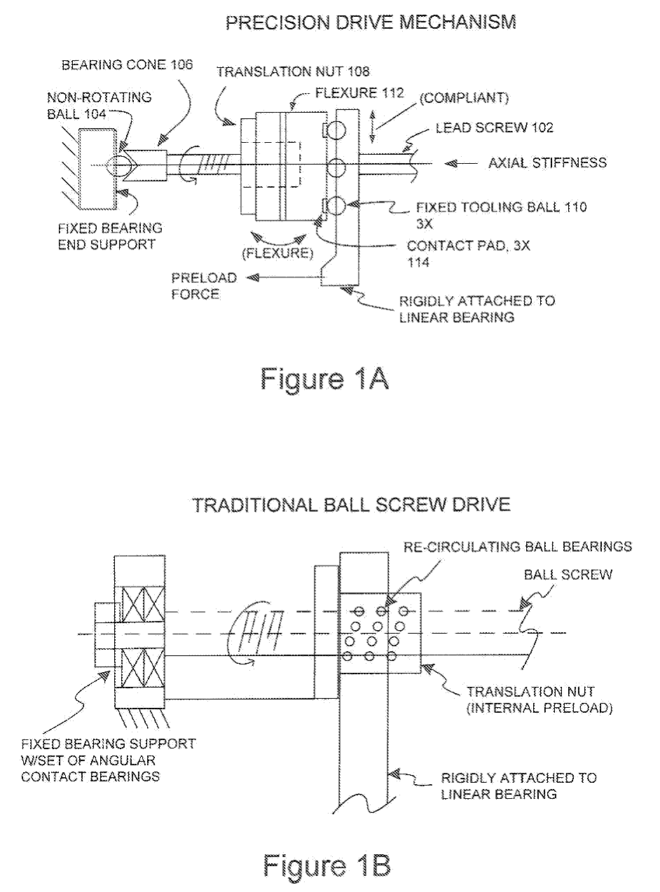

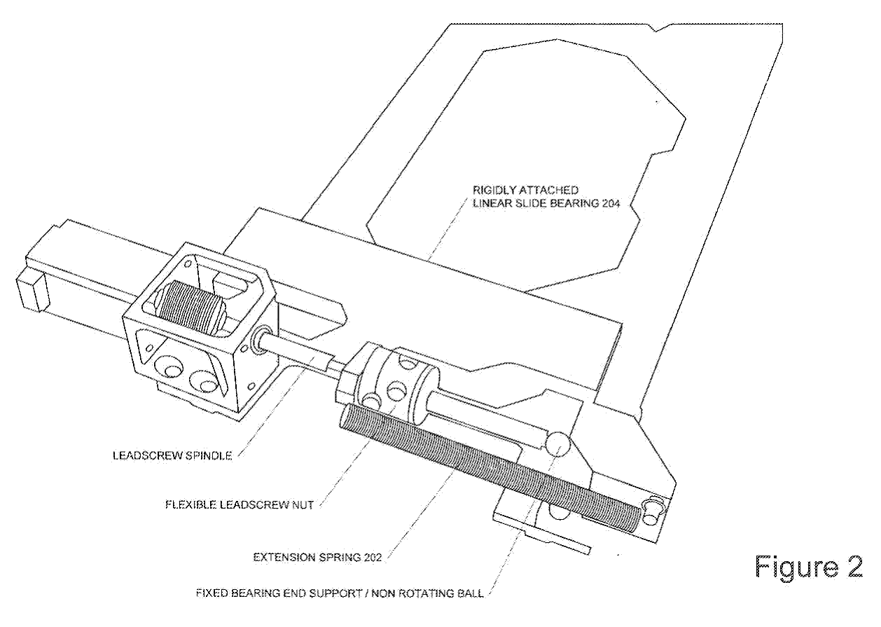

First, certain embodiments of the present invention eliminate intermediary parts such as ball bearings when incorporating a drive screw mechanism into a microscopy translation stage. FIG. 1(a) illustrates how this is accomplished by using a precision lead screw 102, rather than a ball screw, and a fixed ball 104/cone 106 design. This design results in control of the axial position of the translation nut 108 and screw in a kinematic manner. Additionally, the nut threads are continuously preloaded against the screw threads by means of an external tension spring 202, shown in FIG. 2. Thus, due the absence of the moving intermediary bearings, the assembly is able to provide long travel linear motion, and maintain position in a predictable manner.

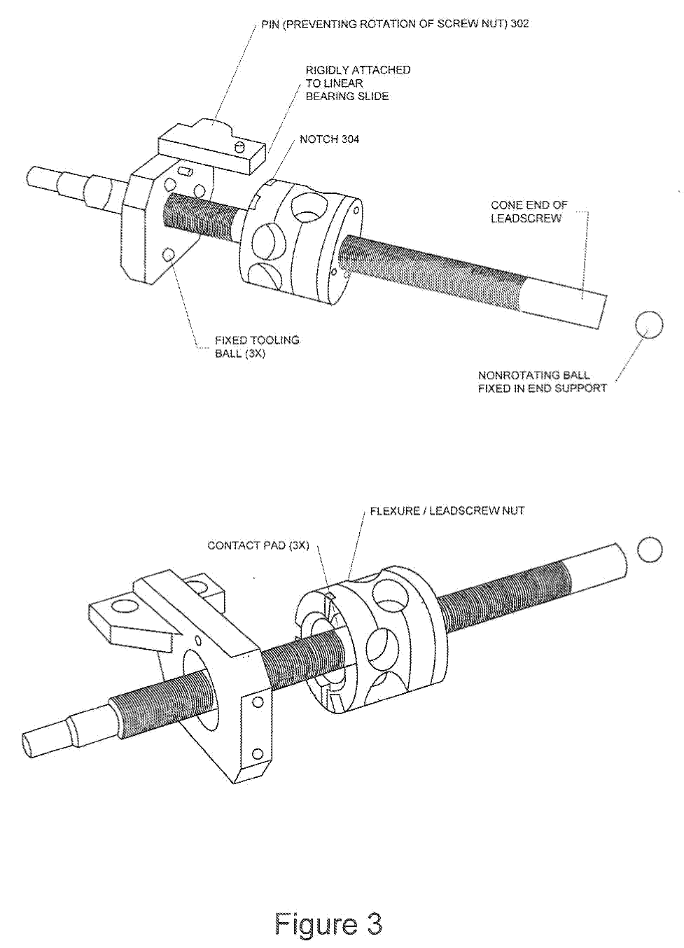

Second, as previously mentioned the design uses a lead screw and nut without intermediary or re-circulating ball bearings. This means that the nut does not have the load capacity of a comparably-sized ball screw, and that mis-alignment between the lead screw and the linear bearing system would result in excess friction between the nut and the screw, resulting in binding and ultimately increased positional repeatability error. In order to minimize errors due to alignment, the design again employs kinematic principles to produce very stiff axial motion, but allows for virtually unconstrained movement in all other degrees of freedom. This is accomplished by using at least three fixed tooling balls 110 mounted into an axially stiff, but angularly compliant flexure mechanism 112 that is rigidly attached to the linear bearing system 204. The balls contact pads 114 which are attached to the lead screw nut, and are held in place by an external spring. In order to prevent the lead screw nut from rotating about the lead screw axis during stage translation the nut is constrained via a pin 302 that registers into a groove 304 in the flexure mechanism as illustrated in FIG. 3. This engagement is rotationally stiff, yet allows for compliance in the other degrees of freedom. There is not a tight fit between the pin and corresponding groove because a loose fit allows for an unconstrained condition. The loose fit also results in “backlash” in the system, but this only occurs when reversing direction of the motor and lead screw mechanism. In the typical use-case scenario for this stage, it is envisioned that backlash resulting from the unconstrained pin-groove engagement is acceptable. During stage translation the three balls are allowed to slide perpendicular to the axial motion, and the flexure mechanism combined with the three balls allows for angular changes between the lead screw nut and the linear bearing system as well. The net result of this design is that driving force is axial transmitted, but the drive nut is effectively de-coupled from the linear bearing system in the remaining five degrees of freedom. Thus a high axial stiffness, smooth motion condition exists, which results in low positional repeatability errors.

The design approach described above results in repeatability positional error of approximately 0.20 microns, an improvement of 5× over a traditional ball screw mechanism of similar proportions. The high cost and complexity of a closed loop, linear-encoded system can be avoided.

### ADDITIONAL DESCRIPTIONS OF CERTAIN ASPECTS OF THE INVENTION

Certain embodiments of the present invention provide a precision drive mechanism comprising a lead screw having a first end coupled by a preloaded ball and cone to an end support, a screw nut, and a flexural mechanism attached to a rigid linear bearing system. Certain embodiments of the present invention provide a method for precision translation of a stage, the method comprising fixing a first end of a lead screw to an end support by a preloaded ball and cone, and coupling a screw nut to a flexural mechanism that is rigidly attached to linear bearing system.

1. A precision drive mechanism comprising:
(a) a lead screw having a first end coupled by a preloaded ball and cone to an end support;
(b) a screw nut; and
(c) a flexural mechanism attached to a rigid linear bearing.

2. The precision drive mechanism of claim 1 wherein the preloaded ball and cone are secured by an external spring.

3. The precision drive mechanism of claim 1 wherein the flexural mechanism comprises at least three balls.

4. The precision drive mechanism of claim 3 wherein the flexural mechanism further comprises at least three contact pads.

5. A method for precision translation of a stage, the method comprising fixing a first end of a lead screw to and end support by a preloaded ball and cone and coupling a screw nut to a flexural mechanism that is attached to a rigid linear bearing system.

6. The method of claim 5 wherein the preloaded ball and cone are secured by an external spring.

7. The method of claim 5 wherein the flexural mechanism comprises at least three balls.

8. The method of claim 7 wherein the flexural mechanism further comprises at least three contact pads.
